(19) United States
(12) Patent Application Publication
(10) Pub. No.: US 2006/0104527 A1
(43) Pub. Date: May 18, 2006

(54) Video image encoding method, video image encoder, and video image encoding program

(75) Inventors: Shinichiro Koto, Kokubunji-shi (JP); Wataru Asano, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/272,481

(22) Filed: Nov. 14, 2005

(30) Foreign Application Priority Data
Nov. 12, 2004 (JP) P2004-328456

(51) Int. Cl. G06K 9/36

(52) U.S. Cl. 382/239; 382/238

(57) ABSTRACT

A method for encoding a video image includes: generating a prediction image for each of a plurality of pixel blocks that are divided from an input image into a predetermined size, and generating a prediction residual signal that indicates prediction residual between the prediction image and each of the pixel blocks, for each of a plurality of prediction modes; obtaining an orthogonal transformation coefficient by performing orthogonal transformation to the prediction residual signal corresponding to each of the prediction modes; selecting a target prediction mode from among the prediction modes based on a number of the orthogonal transformation coefficients that become non-zero as a quantization processing is performed; encoding each of the pixel blocks in the target prediction mode respectively selected.

### RELATED APPLICATIONS

The present disclosure relates to the subject matter contained in Japanese Patent Application No. 2004-328456 filed on Nov. 12, 2004, which is incorporated herein by reference in its entirety.

### BACKGROUND

1. Field of the Invention

The present invention relates to a video image encoding method, a video image encoder, and a video image encoding program product for causing a computer system to select a prediction mode for providing good encoding efficiency and less image quality degradation from among prediction modes and to encode a video image.

2. Description of the Related Art

In the international standards of video image encoding methods such as MPEG-2, MPEG-4, and H.264, a plurality of modes (prediction modes) exist in selecting methods of a reference image to generate a prediction image and a prediction block shape, and generation methods of a prediction residual signal, and the image to be encoded is encoded according to one selected from among the prediction modes for each pixel block. In the video image encoding method for selecting one for each pixel block from among the prediction modes and encoding an image according to the selected prediction mode, the image quality of the coded video image and the code amount for encoding vary depending on the selected prediction mode. Therefore, hitherto, selection methods of a prediction mode for providing good encoding efficiency and less image quality degradation have been proposed.

As a method of selecting a prediction mode for providing good encoding efficiency, for example, a method of executing actual encoding for each prediction mode and selecting the prediction mode corresponding to the smallest code amount is disclosed. (For example, refer to JP-A-2003-153280.) Further, a method of executing actual encoding and finding the code amount for each prediction mode and also finding an error between the original image and decoded image (encoding distortion) for each prediction mode and selecting one prediction mode in the balance between the code amount and the encoding distortion is disclosed. (For example, refer to the document “Rate-constrained coder control and comparison of video encoding standards” cited below.)

In the method of executing actual encoding and finding the code amount and the encoding distortion for each prediction mode, however, if the number of prediction modes is large, the computation amount and the hardware scale required for encoding grow, resulting in an increase in the cost of the encoder although it is made possible to appropriately select the prediction mode for providing good encoding efficiency and less image quality degradation; this is a problem.

T. Wiegand et al., “Rate-constrained coder control and comparison of video encoding standards,” IEEE Trans. Circuits Syst. Video Technol., vol. 13, pp. 688-703, July 2003.

As described above, according to the video image encoding method for executing actual encoding and finding the code amount and the encoding distortion for each prediction mode and selecting one prediction mode accordingly, if the number of prediction modes is large, the computation amount and the hardware scale required for encoding grow, resulting in an increase in the cost of the encoder.

### SUMMARY

The present invention is directed to a video image encoding method, a video image encoder, and a video image encoding program product which allows to select a prediction mode for providing good encoding efficiency and less image quality degradation without increasing the computation amount or the hardware scale for selecting the prediction mode.

According to a first aspect of the invention, there is provided a method for encoding a video image, the method including: generating a prediction image for each of a plurality of pixel blocks that are divided from an input image into a predetermined size, and generating a prediction residual signal that indicates prediction residual between the prediction image and each of the pixel blocks, for each of a plurality of prediction modes; obtaining an orthogonal transformation coefficient by performing orthogonal transformation to the prediction residual signal corresponding to each of the prediction modes; selecting a target prediction mode from among the prediction modes based on a number of the orthogonal transformation coefficients that become non-zero as a quantization processing is performed; encoding each of the pixel blocks in the target prediction mode respectively selected.

According to a second aspect of the invention, there is provided a method for encoding a video image, the method including: selecting a plurality of second prediction modes from among a plurality of first prediction modes based on a pixel rate determined by a frame rate and an image size of an input image, for each of a plurality of pixel blocks that are divided from the input image into a predetermined size; obtaining a coding amount produced by encoding each of the pixel blocks for each of the second prediction modes; obtaining an encoding distortion produced by encoding each of the pixel blocks for each of the second prediction modes; selecting a target prediction mode from among the second prediction modes based on the coding amount and the encoding distortion; and encoding each of the pixel blocks in the target prediction mode respectively selected by the selection unit.

According to a third aspect of the invention, there is provided a video image encoder including: a generation unit that generates a prediction image for each of a plurality of pixel blocks that are divided from an input image into a predetermined size, and generates a prediction residual signal that indicates prediction residual between the prediction image and each of the pixel blocks, for each of a plurality of prediction modes; an orthogonal transformation unit that obtains an orthogonal transformation coefficient by performing orthogonal transformation to the prediction residual signal corresponding to each of the prediction modes; a selection unit that selects a target prediction mode from among the prediction modes based on a number of the orthogonal transformation coefficients that become non-zero as a quantization processing is performed; an encoding unit that encodes each of the pixel blocks in the target prediction mode respectively selected by the selection unit.

According to a fourth aspect of the invention, there is provided a video image encoder including: a first selection unit that selects a plurality of second prediction modes from among a plurality of first prediction modes based on a pixel rate determined by a frame rate and an image size of an input image, for each of a plurality of pixel blocks that are divided from the input image into a predetermined size; a first obtaining unit that obtains a coding amount produced by encoding each of the pixel blocks for each of the second prediction modes; a second obtaining unit that obtains an encoding distortion produced by encoding each of the pixel blocks for each of the second prediction modes; a second selection unit that selects a target prediction mode from among the second prediction modes based on the coding amount and the encoding distortion; and an encoding unit that encodes each of the pixel blocks in the target prediction mode respectively selected by the selection unit.

According to a fifth aspect of the invention, there is provided a computer readable program product that causes a computer system to perform processes including: generating a prediction image for each of a plurality of pixel blocks that are divided from an input image into a predetermined size, and generating a prediction residual signal that indicates prediction residual between the prediction image and each of the pixel blocks, for each of a plurality of prediction modes; obtaining an orthogonal transformation coefficient by performing orthogonal transformation to the prediction residual signal corresponding to each of the prediction modes; selecting a target prediction mode from among the prediction modes based on a number of the orthogonal transformation coefficients that become non-zero as a quantization processing is performed; encoding each of the pixel blocks in the target prediction mode respectively selected.

According to a sixth aspect of the invention, there is provided a computer readable program product that causes a computer system to perform processes including: selecting a plurality of second prediction modes from among a plurality of first prediction modes based on a pixel rate determined by a frame rate and an image size of an input image, for each of a plurality of pixel blocks that are divided from the input image into a predetermined size; obtaining a coding amount produced by encoding each of the pixel blocks for each of the second prediction modes; obtaining an encoding distortion produced by encoding each of the pixel blocks for each of the second prediction modes; selecting a target prediction mode from among the second prediction modes based on the coding amount and the encoding distortion; and encoding each of the pixel blocks in the target prediction mode respectively selected by the selection unit.

### BRIEF DESCRIPTION OF THE DRAWINGS

In the accompanying drawings:

FIG. 1 is a block diagram to show a configuration of a video image encoder according to a first embodiment;

FIG. 2 is a flowchart to show the operation of the video image encoder according to the first embodiment;

FIG. 3 is a drawing to show the relationship between the code amount produced as quantization processing is performed and the number of non-zero coefficients according to the first embodiment;

FIG. 4 is a flowchart to show the prediction mode selection operation in the first embodiment;

FIG. 5 is a block diagram to show a configuration of a video image encoder according to a second embodiment;

FIG. 6 is a flowchart to show the operation of the video image encoder according to the second embodiment;

FIG. 7 is a block diagram to show a configuration of a video image encoder according to a third embodiment;

FIG. 8 is a flowchart to show the operation of the video image encoder according to the third embodiment;

FIG. 9 is a block diagram to show a configuration of a video image encoder according to a fourth embodiment;

FIG. 10 is a flowchart to show the operation of the video image encoder according to the fourth embodiment;

FIG. 11 is a drawing to show the occurrence frequency distribution of the coefficient values of orthogonal transformation coefficient in the fourth embodiment;

FIG. 12 is a drawing to show the relationship between the occurrence frequency distribution of the coefficient values of orthogonal transformation coefficient and quantization representative values in the fourth embodiment;

FIG. 13 is a drawing to show a state in which the occurrence frequency distribution of the coefficient values of orthogonal transformation coefficient is assumed to be a uniform distribution in the fourth embodiment;

FIG. 14 is a flowchart to show the encoding distortion estimation operation in the fourth embodiment;

FIG. 15 is a block diagram to show a configuration of a video image encoder according to a fifth embodiment;

FIG. 16 is a flowchart to show the operation of the video image encoder according to the fifth embodiment;

FIG. 17 is timing charts to show the pipeline operation of the video image encoder according to the fifth embodiment; and

FIG. 18 is a drawing to show examples of images to be encoded by the video image encoder according to the fifth embodiment.

### DETAILED DESCRIPTION

Embodiments of the invention will be described below with reference to the accompanying drawings.

### First Embodiment

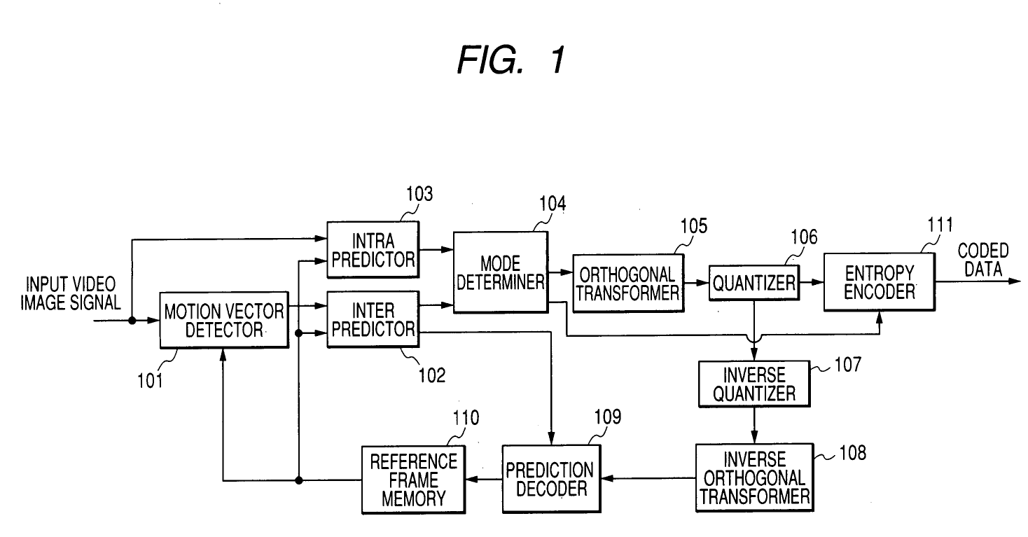

FIG. 1 is a block diagram to show a configuration of a video image encoder according to a first embodiment.

The video image encoder according to the first embodiment includes a motion vector detector 101, an inter predictor (interframe predictor) 102, an intra predictor (intraframe predictor) 103, a mode determiner 104, an orthogonal transformer 105, a quantizer 106, an inverse quantizer 107, an inverse orthogonal transformer 108, a prediction decoder 109, reference frame memory 110, and an entropy encoder 111.

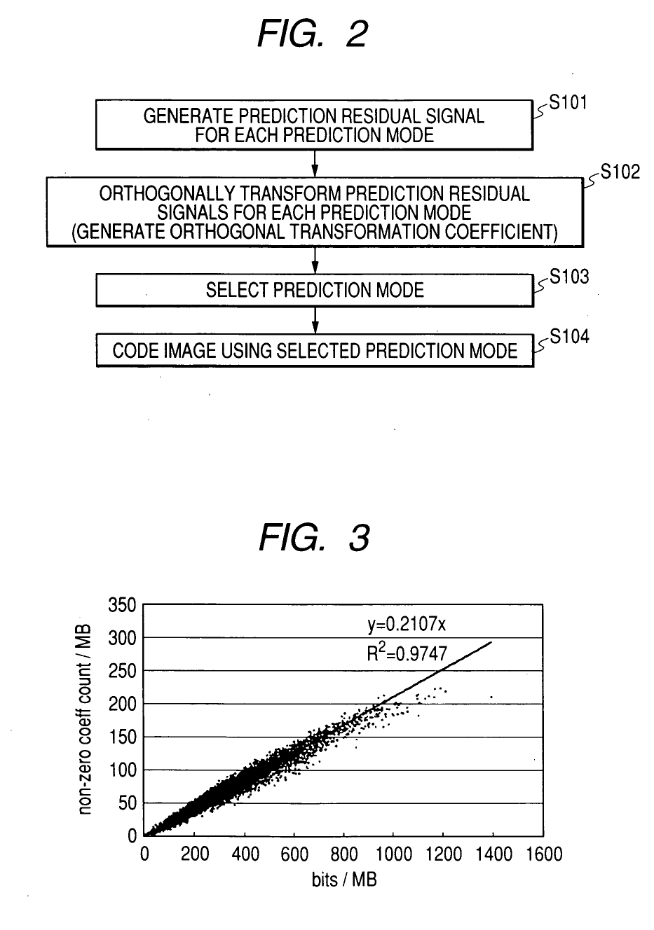

The operation of the video image encoder according to the first embodiment will be described with FIGS. 1 and 2. FIG. 2 is a flowchart to show the operation of the video image encoder according to the first embodiment.

When an input image signal is input to the video image encoder, the input image signal is divided into pixel blocks each of a given size and a prediction image signal is generated according to a plurality of prediction modes for each pixel block. Next, a prediction residual signal is generated from the prediction image signal generated for each prediction mode and the input image signal (pixel block) and is sent to the mode determiner 104.

The generation operation of the prediction residual signal is as follows.

First, the input image signal is sent to the motion vector detector 101. The motion vector detector 101 divides the input image signal into pixel blocks each of a given size and finds a motion vector for a plurality of prediction modes for each pixel block. The expression “prediction mode in the motion vector detector 101” herein is used to mean a “combination of motion compensation parameters” such as the reference image number, read from the reference frame memory 110 to find the shape of a motion compensation prediction block and a motion vector.

The motion vector of each pixel block thus detected for each prediction mode in the motion vector detector 101 is then sent to the inter predictor 102 together with the motion compensation parameter combination in each prediction mode.

The inter predictor 102 executes motion compensation prediction from the motion vector of each pixel block and the motion compensation parameters sent from the motion vector detector 101, and generates a prediction image signal for each prediction mode. Then, the inter predictor 102 generates a prediction residual signal that indicates prediction residual between the prediction image signal of each pixel block generated for each prediction mode and the input image signal.

The input image signal is also sent to the intra predictor 103. The intra predictor 103 divides the input image signal into pixel blocks each of a given size, reads a local decode image in an already coded area in the current frame stored in the reference frame memory 110 for each prediction mode for each pixel block, and performs intraframe prediction processing to generate a prediction image signal. The expression “prediction mode in the intra predictor 103” is used to mean a “combination of prediction parameters” such as the dividing size of the local decode image, and the prediction expression number, which to generate a prediction image from the local decode image in the intraframe prediction processing, for example.

The intra predictor 103 generates a prediction residual signal that indicates prediction residual between the prediction image signal of each pixel block generated for each prediction mode and the input image signal.

The prediction residual signals of each pixel block thus generated for each prediction mode in the inter predictor 102 and the intra predictor 103 are then sent to the mode determiner 104.

The mode determiner 104 first orthogonally transforms the prediction residual signals of each pixel block sent from the inter predictor 102 and the intra predictor 103 to generate an orthogonal transformation coefficient (step S102).

Next, the mode determiner 104 selects the prediction mode corresponding to the smallest code amount produced by encoding the generated orthogonal transformation coefficient of the prediction residual signals for each pixel block (step S103).

Here, a strong correlation exists between the code amount produced by encoding the orthogonal transformation coefficient of the prediction residual signals (horizontal axis) and the number of coefficients becoming non-zero (non-zero coefficients) as quantization processing is performed, of the orthogonal transformation coefficients of the prediction residual signals (vertical axis), as indicated by measurement data in FIG. 3. Then, using this nature, if the number of coefficients becoming non-zero as quantization processing is performed, of the orthogonal transformation coefficients of the prediction residual signals is found for each prediction mode and the pixel block is encoded using the prediction mode corresponding to the smallest number, the code amount produced by encoding can be lessened and it is made possible to execute efficient encoding.

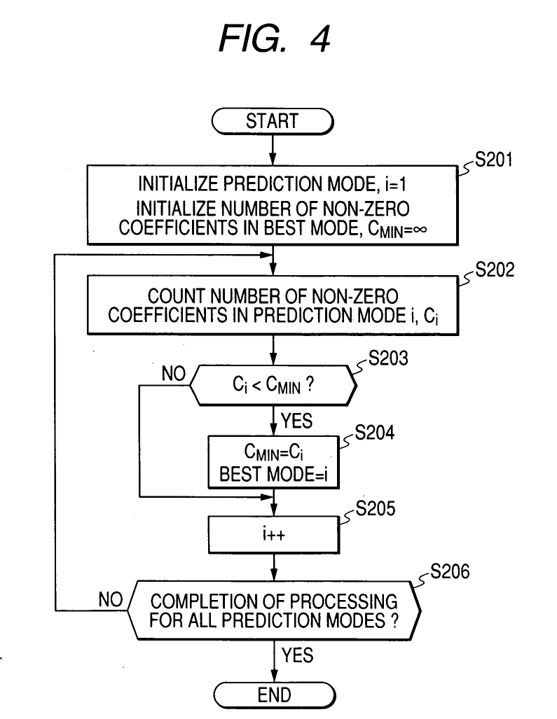

FIG. 4 is a flowchart to show the operation of the mode determiner 104 for selecting the prediction mode corresponding to the smallest number of non-zero coefficients from the orthogonal transformation coefficients of the prediction residual signals.

First, prediction mode number “i” is initialized and the number of non-zero coefficients in the best mode, CMIN, is set to a predetermined value (step S201).

Next, the number of coefficients becoming non-zero as quantization processing is performed, of the orthogonal transformation coefficients of the prediction residual signals in the prediction mode “i”, Cᵢ, is counted (step S202). The number of non-zero coefficients may be found, for example, by actually quantizing orthogonal transformation coefficients and counting the number of coefficients becoming non-zero or by previously finding the maximum value of the coefficients quantized to zero by performing quantization processing from the quantization step width and comparing the maximum value as a threshold value with each orthogonal transformation coefficient and counting the number of coefficients larger than the threshold value. The number of non-zero coefficients may be found by finding the number of coefficients becoming zero as quantization processing is performed, of the orthogonal transformation coefficients of the prediction residual signals and calculating the difference between the number of coefficients becoming zero and the number of pixels contained in the pixel block.

Next, the number of non-zero coefficients in the prediction mode “i”, Cᵢ, is compared with the number of non-zero coefficients in the best mode, C_{MIN} (step S203). At this time, if Cᵢ is smaller than C_{MIN}, the process proceeds to step S204; if Cᵢ is equal to or greater than C_{MIN}, the process proceeds to step S205.

If Cᵢ is smaller than C_{MIN}, Cᵢ is assigned to the number of non-zero coefficients in the best mode, C_{MIN}, and the prediction mode “i” is set as the best mode (step S204).

Next, the prediction mode number “i” is incremented by one (step S205) and whether or not processing for all prediction modes is complete is determined (step S206). If processing for all prediction modes is not complete, the process returns to step S202 and the number of non-zero coefficients is counted for new prediction mode number “i”. If processing for all prediction modes is complete, the processing is terminated. The prediction mode set as the best mode at the time becomes the prediction mode selected in the mode determiner 104.

The prediction mode selection processing in the mode determiner 104 is performed for each pixel block and one prediction mode is selected for each pixel block.

When the prediction mode is selected in the mode determiner 104, the prediction residual signal corresponding to the prediction mode selected for each pixel block is sent to the orthogonal transformer 105, which then transforms the prediction residual signal into an orthogonal transformation coefficient. This orthogonal transformation coefficient is quantized by the quantizer 106 and is output by the entropy encoder 111 as coded data (step S104). The mode determiner 104 also sends information of the selected prediction mode to the entropy encoder 111, which then also codes the prediction mode information and outputs the coded data.

The orthogonal transformation coefficient of the prediction residual signal quantized by the quantizer 106 is stored in the reference frame memory 110 as a local decode image through the inverse quantizer 107, the inverse orthogonal transformer 108, and the prediction decoder 109.

Thus, the video image encoder according to the first embodiment finds the number of coefficients becoming non-zero as quantization processing is performed, of the orthogonal transformation coefficients of the prediction residual signals for each prediction mode and selects the prediction mode corresponding to the smallest number of non-zero coefficients and codes the pixel block according to the selected prediction mode, thereby making it possible to execute efficient encoding without performing actual encoding processing to select the prediction mode.

In the embodiment described above, the mode determiner 104 finds the orthogonal transformation coefficient from the prediction residual signal and selects the prediction mode and the orthogonal transformer 105 again orthogonally transforms the prediction residual signal to find an orthogonal transformation coefficient. However, the orthogonal transformation coefficient found by the mode determiner 104 may be stored in additional memory and the orthogonal transformation coefficient corresponding to the prediction mode selected by the mode determiner 104 may be read from the memory and may be sent directly to the quantizer 106. This mode eliminates the need for duplicately generating the orthogonal transformation coefficient and makes it possible to reduce the calculation amount for encoding.

The video image encoder can also be implemented by using a general-purpose computer as the basic hardware, for example. That is, the motion vector detector 101, the inter predictor 102, the intra predictor 103, the mode determiner 104, the orthogonal transformer 105, the quantizer 106, the inverse quantizer 107, the inverse orthogonal transformer 108, the prediction decoder 109, and the entropy encoder 111 can be implemented as a processor installed in the computer is caused to execute a program. At this time, the video image encoder may be implemented as the program is previously installed in the computer or may be implemented as the program is stored on a record medium such as a CD-ROM or is distributed through a network and is installed in the computer whenever necessary. The reference frame memory 110 can be implemented appropriately using memory, a hard disk, or any other record medium such as a CD-R, a CD-RW, a DVD-RAM, or a DVD-R installed inside or outside the computer.

### Second Embodiment

In the first embodiment, using the fact that there is a correlation between the code amount produced by encoding the orthogonal transformation coefficient of the prediction residual signals and the number of coefficients becoming non-zero as quantization processing is performed, of the orthogonal transformation coefficients of the prediction residual signals, the number of non-zero coefficients is found for each prediction mode and the prediction mode corresponding to the smallest number of non-zero coefficients is selected.

In a second embodiment, a prediction mode selection method will be described also considering the correlation difference for each prediction mode.

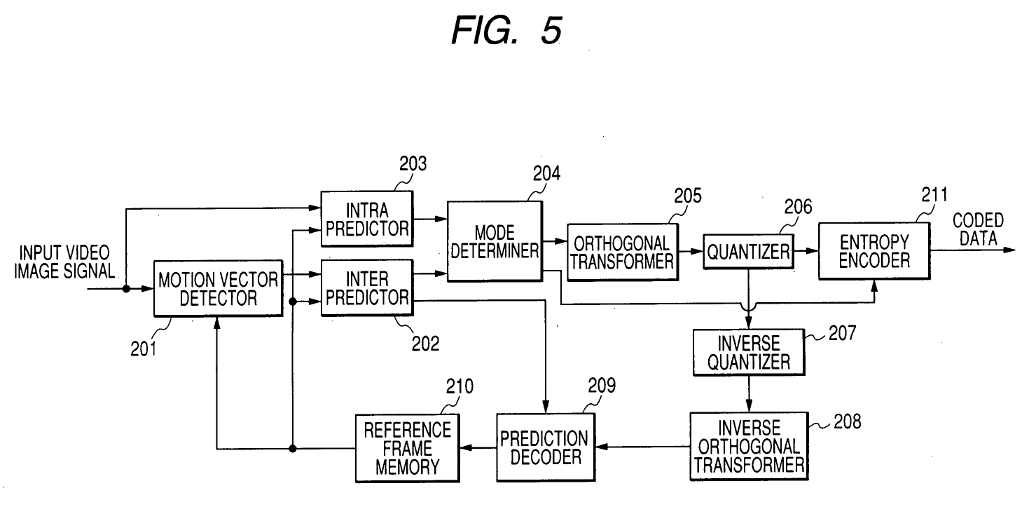

FIG. 5 is a block diagram to show the configuration of a video image encoder according to the second embodiment.

The video image encoder according to the second embodiment includes a motion vector detector 201, an inter predictor 202, an intra predictor 203, a mode determiner 204, an orthogonal transformer 205, a quantizer 206, an inverse quantizer 207, an inverse orthogonal transformer 208, a prediction decoder 209, reference frame memory 210, and an entropy encoder 211.

That is, the video image encoder according to the second embodiment has the same configuration as the video image encoder according to the first embodiment; they differ only in prediction mode selection operation in the mode determiner 204. Therefore, the parts for performing common operation to those of the video image encoder according to the first embodiment (motion vector detector 201, inter predictor 202, intra predictor 203, orthogonal transformer 205, quantizer 206, inverse quantizer 207, inverse orthogonal transformer 208, prediction decoder 209, reference frame memory 210, and entropy encoder 211) will not be described again.

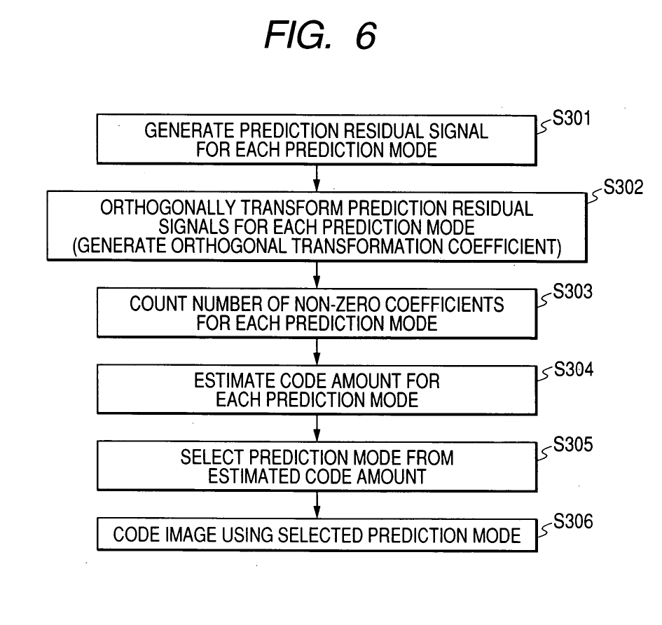

Next, the operation of the video image encoder according to the second embodiment will be described with FIGS. 5 and 6. FIG. 6 is a flowchart to show the operation of the video image encoder according to the second embodiment.

First, prediction residual signals generated for each prediction mode in the inter predictor 202 and the intra predictor 203 are input to the mode determiner 204 (step S301).

The mode determiner 204 orthogonally transforms the prediction residual signals of each pixel block sent from the inter predictor 202 and the intra predictor 203 to generate an orthogonal transformation coefficient (step S302).

Next, the mode determiner 204 selects the prediction mode corresponding to the smallest code amount produced by encoding the generated orthogonal transformation coefficient of the prediction residual signals for each pixel block (steps S303 to S305).

Here, a strong correlation exists between the code amount produced by encoding the orthogonal transformation coefficient of the prediction residual signals and the number of coefficients becoming non-zero as quantization processing is performed, of the orthogonal transformation coefficients of the prediction residual signals, as described above. The correlation varies depending on the prediction mode generating the prediction residual signals. Therefore, letting the number of non-zero coefficients involved in the prediction mode “i” be Cᵢ, the code amount R_{Ci} produced by encoding the pixel block using the prediction mode “i” can be estimated, for example, according to expression (1) from the correlation described above:
R_{Ci}=αᵢ·Cᵢ (1)

In the expression (1), αᵢ is the weighting factor representing the correlation in the prediction mode “i”. The weighting factor αᵢ may be previously found experimentally using moving image data for learning.

Then, the mode determiner 204 first counts the number of coefficients becoming non-zero as quantization processing of the orthogonal transformation coefficient of the prediction residual signals is performed for each prediction mode (step S303). Next, the mode determiner 204 estimates the code amount produced by encoding the orthogonal transformation coefficient of the prediction residual signals according to expression (1) for each prediction mode (step S304). The mode determiner 204 selects the prediction mode to be used for encoding from the estimated code amount R_{Ci} (step S305). To select the prediction mode, the prediction mode wherein the estimated code amount R_{Ci} becomes the minimum may be selected.

The prediction mode selection processing in the mode determiner 204 is performed for each pixel block and one prediction mode is selected for each pixel block.

When the prediction mode is selected in the mode determiner 204, the prediction residual signal corresponding to the prediction mode selected for each pixel block is sent to the orthogonal transformer 205, which then transforms the prediction residual signal into an orthogonal transformation coefficient. This orthogonal transformation coefficient is quantized by the quantizer 206 and is output by the entropy encoder 211 as coded data (step S306).

Thus, the video image encoder according to the second embodiment estimates the code amount produced by encoding the orthogonal transformation coefficient of the prediction residual signals from the number of non-zero coefficients for each prediction mode and selects the prediction mode according to the estimated code amount, thereby making it possible to execute efficient encoding also considering the correlation between the number of non-zero coefficients and the code amount for each prediction mode.

In the embodiment described above, the weighting factor αᵢ representing the correlation in the prediction mode “i” is a constant previously found experimentally, but the weighting factor can also be updated successively using the number of non-zero coefficients in the pixel block already coded and the code amount actually produced by encoding the pixel block. That is, the weighting factor αᵢ is updated, for example, according to expression (2) from the number of non-zero coefficients involved in the prediction mode selected in the mode determiner 204, Cᵢ, and the code amount R′_{C} produced by encoding the pixel block using the prediction mode obtained from the entropy encoder 211.

$${α}_{i} = \frac{{R}_{c}^{′}}{{C}_{i}} \qquad ( 2 )$$

The weighting factor αᵢ is thus updated successively, whereby it is made possible to estimate the code amount with higher precision.

Further, the weighting factor αᵢ may be updated using the number of non-zero coefficients in a plurality of pixel blocks coded in the past and the code amount or may be updated using the code amount of the pixel blocks of the whole immediately preceding frame already coded and the number of non-zero coefficients. The weighting factor αᵢ is thus updated using the encoding result of a plurality of pixel blocks, so that it is made possible to estimate the value of the weighting factor more accurately.

### Third Embodiment

In the second embodiment, the code amount produced by encoding each pixel block is estimated from the number of coefficients becoming non-zero as quantization processing is performed, of the orthogonal transformation coefficients of the prediction residual signals, and the prediction mode wherein the estimated code amount becomes the minimum is selected.

In a third embodiment, a method of selecting a prediction mode by also estimating the code amount produced by encoding additional information relevant to the prediction mode such as a motion vector to generate a prediction image and the number of a reference image to generate a prediction image will be described.

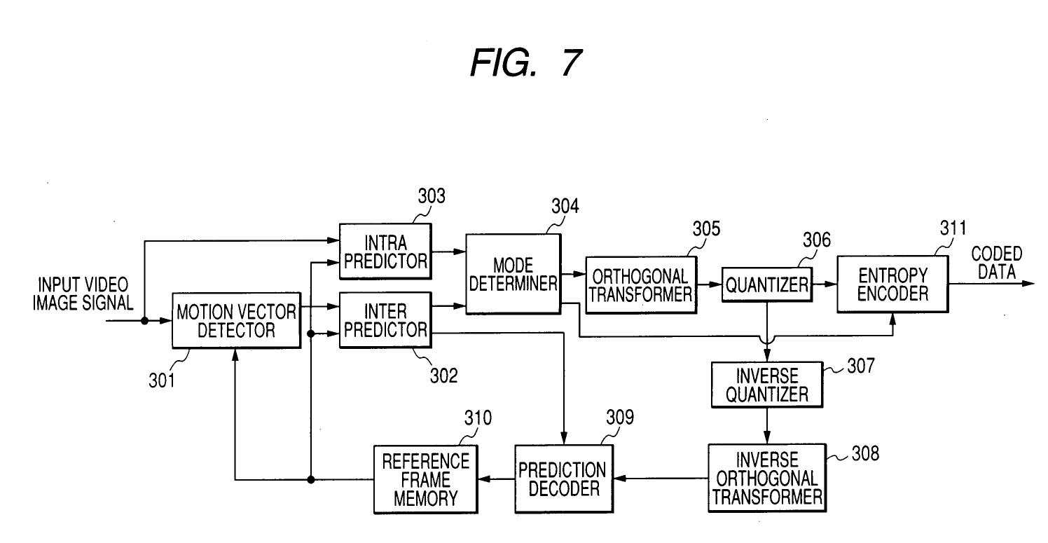

FIG. 7 is a block diagram to show the configuration of a video image encoder according to the third embodiment.

The video image encoder according to the third embodiment includes a motion vector detector 301, an inter predictor 302, an intra predictor 303, a mode determiner 304, an orthogonal transformer 305, a quantizer 306, an inverse quantizer 307, an inverse orthogonal transformer 308, a prediction decoder 309, reference frame memory 310, and an entropy encoder 311.

That is, the video image encoder according to the third embodiment has the same configuration as the video image encoder according to the second embodiment; they differ only in prediction mode selection operation in the mode determiner 304. Therefore, the parts for performing common operation to those of the video image encoder according to the second embodiment (motion vector detector 301, inter predictor 302, intra predictor 303, orthogonal transformer 305, quantizer 306, inverse quantizer 307, inverse orthogonal transformer 308, prediction decoder 309, reference frame memory 310, and entropy encoder 311) will not be described again.

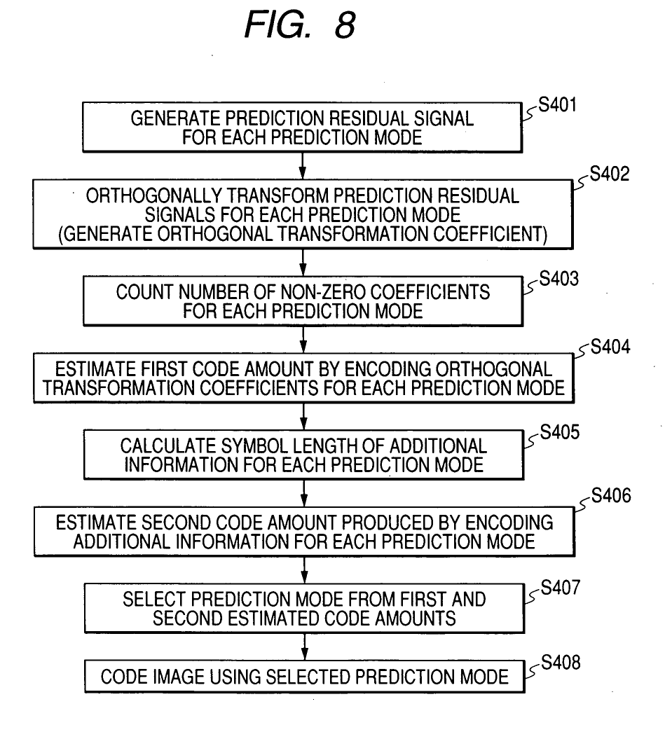

Next, the operation of the video image encoder according to the third embodiment will be described with FIGS. 7 and 8. FIG. 8 is a flowchart to show the operation of the video image encoder according to the third embodiment.

First, prediction residual signals generated for each prediction mode in the inter predictor 302 and the intra predictor 303 and the additional information relevant to each prediction mode are input to the mode determiner 304 (step S401). The additional information relevant to each prediction mode refers to information for determining the encoding processing method, such as a motion vector generated in the motion vector detector 301, the number of a reference image to generate a prediction image, the number of a prediction expression to generate a prediction image from the reference image, or the pixel block shape, and refers to information stored or transmitted to a decoder together with the coded pixel block. The additional information may be one piece of the information or may be a combination of the information pieces.

The mode determiner 304 orthogonally transforms the prediction residual signals of each pixel block sent from the inter predictor 302 and the intra predictor 303 to generate an orthogonal transformation coefficient (step S402).

Next, the mode determiner 304 estimates a first code amount produced by encoding the generated orthogonal transformation coefficient of the prediction residual signals for each pixel block (steps S403 and S404).

The first code amount can be estimated by finding the number of coefficients becoming non-zero by quantizing the orthogonal transformation coefficients for each prediction mode, Cᵢ, as described above (step S403) and multiplying the number of coefficients becoming non-zero, Cᵢ, by a given weighting factor αᵢ according to expression (1) (step S404).

Next, the mode determiner 304 estimates a second code amount produced by encoding the additional information relevant to the prediction mode for each pixel block (steps S405 and S406).

The second code amount can be estimated, for example, by finding sum total SOH of symbol lengths when each piece of the information is converted into a binarization symbol (step S405) and multiplying the sum total S_{OH} of symbol lengths by a given weighting factor β (step S406). That is, the second code amount corresponding to prediction mode “i”, R_{OHi}, can be estimated according to expression (3).
R_{OHi}=βᵢS_{OHi} (3)

In the expression (3), βᵢ is a weighting factor in the prediction mode “i” and S_{OHi} is the sum total of the symbol lengths of the additional information in the prediction mode “i”. The weighting factor βᵢ may be previously found experimentally using moving image data for learning.

Next, the mode determiner 304 finds sum R of the first code amount and the second code amount estimated according to expressions (1) and (3) for each prediction mode according to expression (4), and selects the prediction mode wherein the-sum R becomes the minimum (step S407).
R=R_{Ci}+R_{OHi} (4)

The prediction mode selection processing performed by the mode determiner 304 is performed for each pixel block and one prediction mode is selected for each pixel block.

When the prediction mode is selected in the mode determiner 304, the prediction residual signal corresponding to the prediction mode selected for each pixel block is sent to the orthogonal transformer 305, which then transforms the prediction residual signal into an orthogonal transformation coefficient. The orthogonal transformation coefficient is quantized by the quantizer 306 and is output by the entropy encoder 311 as coded data (step S408).

Thus, the video image encoder according to the third embodiment can select the prediction mode involving the small code amount produced by encoding considering not only the code amount produced by encoding the orthogonal transformation coefficient of the prediction residual signals, but also the code amount produced by encoding the additional information relevant to the prediction mode, thus making it possible to execute more efficient encoding.

In the embodiment described above, the weighting factor βᵢ for the symbol length in the prediction mode “i” is a constant previously found experimentally, but the weighting factor can also be updated successively using the symbol length of the additional information already coded and the code amount actually produced by encoding the additional information. That is, the weighting factor βᵢ may be updated, for example, according to expression (5) from the symbol length of the additional information relevant to the prediction mode selected in the mode determiner 304, S_{OHi}, and the code amount produced by encoding the additional information relevant to the prediction mode obtained from the entropy encoder 311, R′_{OH}.

$${β}_{i} = \frac{{R}_{OH}^{′}}{{S}_{OHi}} \qquad ( 5 )$$

The weighting factor βᵢ is thus updated successively, whereby it is made possible to estimate the code amount with higher precision.

### Fourth Embodiment

In the third embodiment, the code amount produced by encoding the orthogonal transformation coefficient of the prediction residual signals for each prediction mode and the code amount produced by encoding the additional information relevant to the prediction mode are estimated, and the prediction mode wherein the weighted sum of the code amounts becomes the minimum is selected.

In a fourth embodiment, further a method of selecting a prediction mode by also considering an encoding distortion produced by encoding the orthogonal transformation coefficient of prediction residual signals for each prediction mode will be described.

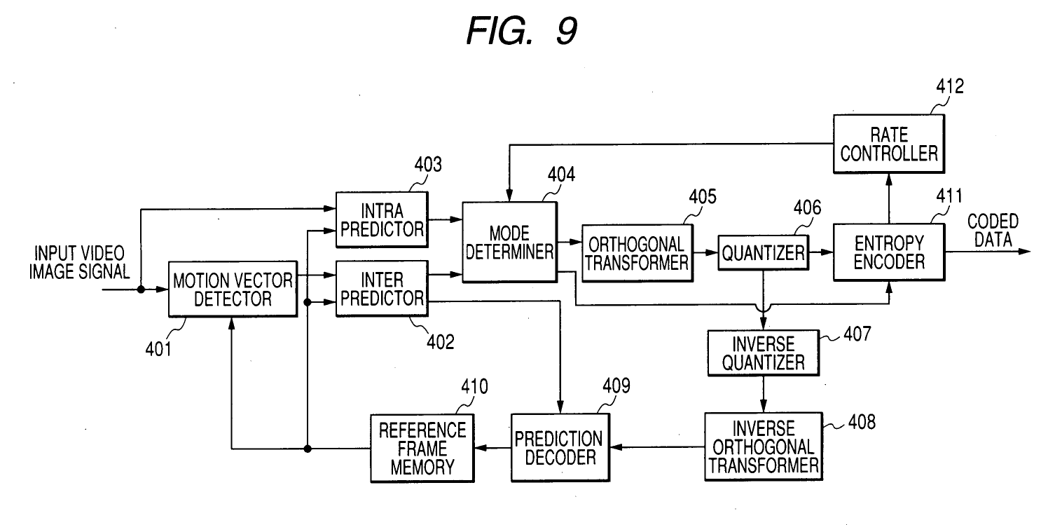

FIG. 9 is a block diagram to show the configuration of a video image encoder according to the fourth embodiment.

The video image encoder according to the fourth embodiment includes a motion vector detector 401, an inter predictor 402, an intra predictor 403, a mode determiner 404, an orthogonal transformer 405, a quantizer 406, an inverse quantizer 407, an inverse orthogonal transformer 408, a prediction decoder 409, reference frame memory 410, an entropy encoder 411, and a rate controller 412.

That is, the video image encoder according to the fourth embodiment differs from the video image encoder according to the third embodiment only in a rate controller 412 and prediction mode selection operation in the mode determiner 404. Therefore, the parts for performing common operation to those of the video image encoder according to the third embodiment (motion vector detector 401, inter predictor 402, intra predictor 403, orthogonal transformer 405, quantizer 406, inverse quantizer 407, inverse orthogonal transformer 408, prediction decoder 409, reference frame memory 410, and entropy encoder 411) will not be described again.

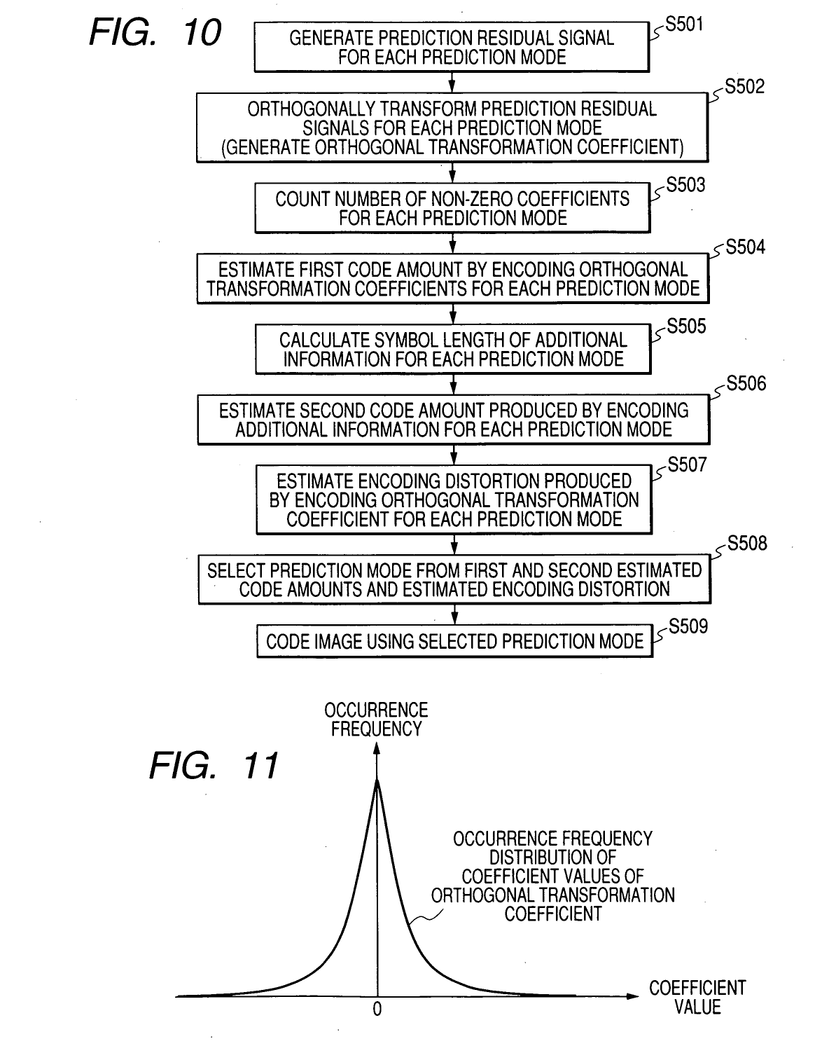

Next, the operation of the video image encoder according to the fourth embodiment will be described with FIGS. 9 and 10. FIG. 10 is a flowchart to show the operation of the video image encoder according to the fourth embodiment.

First, the mode determiner 404 estimates a first code amount produced by encoding the orthogonal transformation coefficient of prediction residual signals for each pixel block and a second code amount produced by encoding the additional information relevant to the prediction mode.

Next, the mode determiner 404 estimates encoding distortion produced by encoding the orthogonal transformation coefficient of the prediction residual signals using the quantization step width input from the rate controller 412 (step S507).

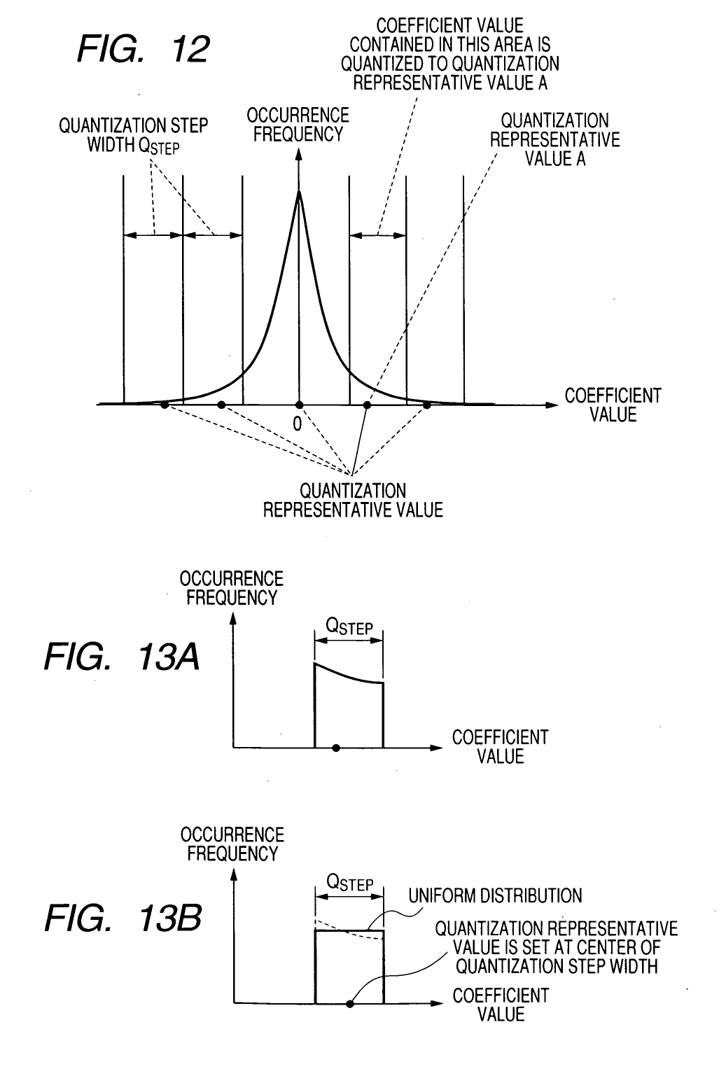

Here, the encoding distortion produced by encoding the orthogonal transformation coefficient of the prediction residual signals is caused by quantization distortion produced by quantizing the orthogonal transformation coefficient. Generally, the occurrence frequency distribution of the coefficient values of the orthogonal transformation coefficient of the prediction residual signals can be approximated by a Laplace distribution. FIG. 11 shows a distribution example of the coefficient values when the occurrence frequency distribution of the coefficient values of the orthogonal transformation coefficient is approximated by a Laplace distribution. FIG. 12 shows the distribution of the coefficient values when the occurrence frequency distribution of the coefficient values of the orthogonal transformation coefficient is approximated by a Laplace distribution and the quantization representative values for quantizing the coefficient value by quantization step width Q_{STEP}. If the occurrence frequency distribution of the coefficient values can be approximated by a Laplace distribution, often the quantization representative value is set slightly close to the origin rather than the center in the range partitioned according to the quantization step width to lessen the average value of quantization distortion produced by quantizing the coefficient values.

Here, quantization distortion “d” when coefficient value aᵢ of the orthogonal transformation coefficient of the prediction residual signals is quantized to quantization representative value Qⱼ can be found according to expression (6).
d=(aᵢ−Qⱼ)² (6)

Particularly, if the quantization representative value Qⱼ is zero, namely, if the coefficient value is quantized to zero, the quantization distortion “d” can be calculated as in expression.
d=aᵢ² (7)

On the other hand, in the area wherein the coefficient value is large and is quantized to the quantization representative value other than zero, it can be assumed that the occurrence frequency distribution of the coefficient values as in FIG. 13A is a uniform distribution in the range of the quantization step width as shown in FIG. 13B and therefore it is known that if it is assumed that the quantization representative value is set at the center of the quantization step width, the average value of the quantization distortion in each coefficient value can be calculated according to expression.

$$d = \frac{{Q}_{STEP} \times {Q}_{STEP}}{12} \qquad ( 8 )$$

Thus, if the estimation value of the quantization distortion is calculated according to expression (8) in the large coefficient value area wherein it can be assumed that the coefficient values are uniformly distributed in the range of the quantization step width and the quantization distortion is calculated according to expression (6) in any other area, it is made possible to efficiently estimate the quantization distortion accompanying quantization of the orthogonal transformation coefficient. The sum total of the quantization distortion may be adopted as the encoding distortion in each prediction mode.

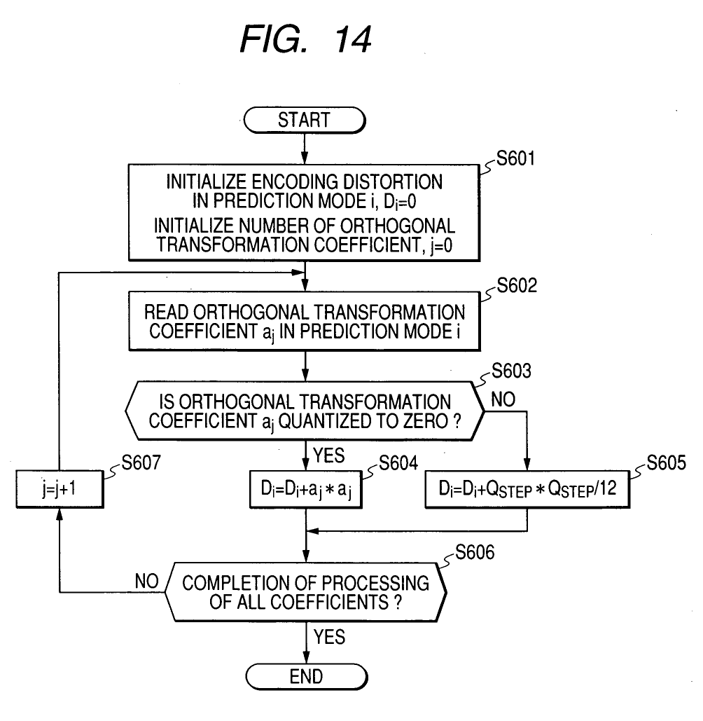

FIG. 14 is a flowchart to show the operation of estimating the encoding distortion in the prediction mode “i” in the mode determiner 404.

First, value Dᵢ of the encoding distortion in the prediction mode “i” is initialized and number “j” of the orthogonal transformation coefficient to be processed is also reset (step S601).

Next, orthogonal transformation coefficient aⱼ is read (step S602) and whether or not the orthogonal transformation coefficient aⱼ is quantized to zero is determined (step S603). If the orthogonal transformation coefficient aⱼ is quantized to zero, the quantization distortion is calculated according to expression (7) and is added to the encoding distortion Dᵢ (step S604). On the other hand, if the orthogonal transformation coefficient aⱼ is quantized to any value than zero, the quantization distortion is calculated according to expression (8) and is added to the encoding distortion Dᵢ (step S605). The quantization distortion calculated according to expression (8) is a constant determined by the quantization step width and therefore when the quantization step width is input to the mode determiner 404 from the rate controller 412, if the quantization distortion is calculated only once and is later used, the quantization distortion need not again be calculated.

The determination as to whether or not the orthogonal transformation coefficient aⱼ is quantized to zero may be made by actually quantizing the orthogonal transformation coefficient aⱼ. However, efficient determination can be made as follows: The maximum coefficient value when the orthogonal transformation coefficient aⱼ is quantized to zero is previously found as a threshold value and a comparison is made between the threshold value and the orthogonal transformation coefficient aⱼ and if the orthogonal transformation coefficient aⱼ is smaller than the threshold value, it is determined that the orthogonal transformation coefficient aⱼ is quantized to zero.

Upon completion of calculating the encoding distortion, then whether or not processing of all orthogonal transformation coefficients is complete is determined (step S606). If processing of all orthogonal transformation coefficients is not complete, the value “j” is incremented by one (step S607) and again the encoding distortion is calculated and if processing of all orthogonal transformation coefficients is complete, the processing is terminated.

Thus, whether or not the orthogonal transformation coefficient is quantized to zero is determined and for the coefficient quantized to zero, the detailed quantization distortion value is found according to expression (7) and for any other coefficient, the predetermined value found according to expression (8) is used as the quantization distortion value, whereby it is made possible to more efficiently find the encoding distortion produced by encoding the orthogonal transformation coefficient.

Next, the mode determiner 404 selects one prediction mode for each pixel block from the first and second estimated code amounts and the estimated encoding distortion (step S508). To select thepredictionmode, the weighted sum Jᵢ of the first code amount R_{Ci}, the second code amount R_{OHi}, and the encoding distortion Dᵢ may be found according to expression (9) and the prediction mode wherein the weighted sum Jᵢ is the minimum may be selected.
Jᵢ=Dᵢ+λ(R_{Ci}+R_{OHi}) (9)

In the expression (9), “λ” is a constant determined according to expression (10) using the quantization step width Q_{STEP} sent from the rate controller 412.

$$λ = \sqrt{0.85 \times {2}^{\frac{( {Q}_{STEP - 12} )}{3}}} \qquad ( 10 )$$

The prediction mode selection processing in the mode determiner 404 is performed for each pixel block and one prediction mode is selected for each pixel block.

When the prediction mode is selected in the mode determiner 404, the prediction residual signal corresponding to the prediction mode selected for each pixel block is sent to the orthogonal transformer 405, which then transforms the prediction residual signal into an orthogonal transformation coefficient. This orthogonal transformation coefficient is quantized by the quantizer 406 and is output by the entropy encoder 411 as coded data (step S509).

The entropy encoder 411 inputs information of the code amount in the pixel block unit to the rate controller 412, which then determines the quantization step width in the pixel block unit and sends the quantization step width to the mode determiner 404.

Thus, the video image encoder according to the fourth embodiment estimates not only the code amount produced by encoding for each prediction mode, but also the encoding distortion produced by encoding and selects the prediction mode based on the code amount and the encoding distortion, so that it is made possible to execute encoding with higher precision. To estimate the encoding distortion, the accurate quantization distortion value is found for the orthogonal transformation coefficient quantized to zero by quantization processing and the predetermined constant is used as the estimated value of the quantization distortion for any other orthogonal transformation coefficient, so that more efficient estimation can be conducted.

In the embodiment described above, the quantization distortion d of the orthogonal transformation coefficient is found by squaring the difference between the coefficient value aᵢ of the orthogonal transformation coefficient and the quantization representative value Qⱼ, but the absolute value of the difference between the coefficient value aᵢ of the orthogonal transformation coefficient and the quantization representative value Qⱼ may be adopted as the quantization distortion d as shown in expression.
d=|aᵢ−Qⱼ| (11)

At this time, in the area quantized to the quantization representative value other than zero, the square root of the value found according to expression (8) may be adopted as the quantization distortion.

Thus, the absolute value of the difference between the coefficient value aᵢ of the orthogonal transformation coefficient and the quantization representative value Qⱼ is adopted as the quantization distortion, whereby calculation of squaring can be skipped, so that it is made possible to calculate the quantization distortion at higher speed.

### Fifth Embodiment

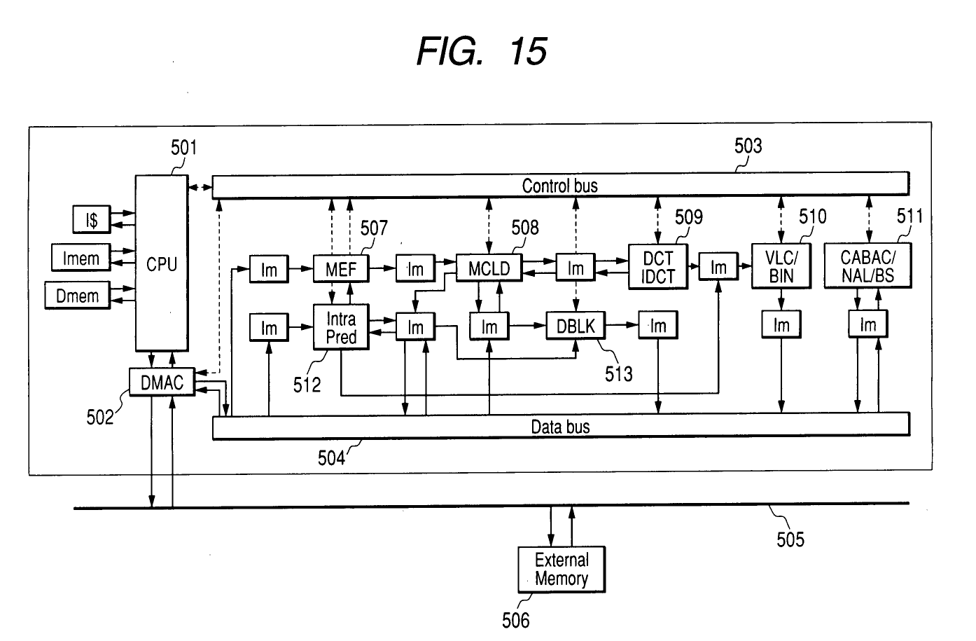

FIG. 15 is a block diagram to show the hardware configuration of a video image encoder according to a fifth embodiment.

The video image encoder according to the fifth embodiment has a plurality of hardware modules connected by a control bus 503 and controlled by a CPU 501. Data transfer between the hardware modules is executed via local memory (lm). Data transfer to and from the outside of the video image encoder is executed from external memory 506 via an external data bus 505 and an internal data bus 504 under the control of a DMA controller (DMAC) 502.

The hardware modules for encoding processing include MEF 507 for detecting a motion vector, an MCLD 508 for performing motion compensation processing and generating a local decode image, a DCTIDCT 509 for performing orthogonal transformation, quantization, inverse quantization, inverse orthogonal transformation, a VCL/BIN 510 for performing variable-length encoding or variable-length symbolization, a CABAC/NAL/BS 511 for performing arithmetic encoding of a variable-length symbol, an IntraPred 512 for performing intraframe prediction, and a DBLK 513 for performing deblocking loop filter processing.

In the video image encoder having the configuration as shown in FIG. 15, the maximum pixel rate at which encoding processing can be performed (the number of pixels per second) is determined by the performance of the CPU, etc. Thus, to select one from among prediction modes and perform encoding processing in the video image encoder, when the frame rate of video image data is high or the image size of video image data is large, if encoding processing is performed for all prediction modes to select the prediction mode corresponding to the small code amount or encoding distortion, the pixel rate at which encoding processing must be performed exceeds the maximum pixel rate that can be handled by the hardware and real-time encoding becomes impossible.

On the other hand, to perform encoding processing only using one previously selected prediction mode, when the frame rate of video image data is low or the image size of video image data is small, the pixel rate at which encoding processing is performed becomes smaller than the maximum pixel rate that can be handled by the hardware and thus there is a surplus of the hardware resources.

Therefore, to make the most of the hardware resources without exceeding the maximum pixel rate that can be handled by the hardware, it is advisable to first select a given number of prediction modes from among prediction modes in response to the frame rate and the image size of video image data and then perform encoding processing only with the selected prediction modes.

Particularly, for example, when a program on a high-definition TV (HDTV) is recorded, if the horizontal size of a screen is halved for encoding to realize long recording or a program on a high-definition TV (HDTV) is down converted into a program on a standard quality TV (SDVT) for encoding to realize longer recording, it is desirable that the hardware resources should be used efficiently and encoding processing should be performed with a plurality of prediction modes before the prediction mode corresponding to less image quality degradation is selected.

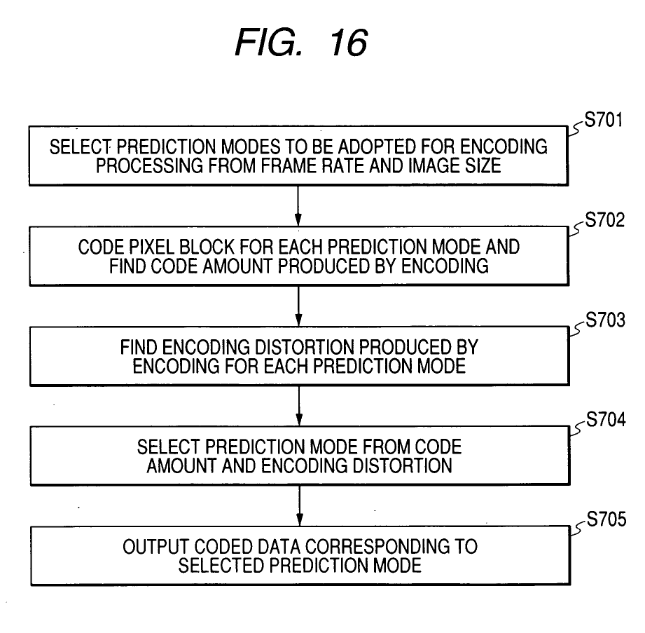

Next, the operation of the video image encoder according to the fifth embodiment will be described with FIGS. 15 and 16. FIG. 16 is a flowchart to show the operation of the video image encoder according to the fifth embodiment.

First, the CPU determines the number of prediction modes to be adopted for encoding processing from the frame rate and the image size of video image data, and selects as many prediction modes as the determined number (step S701). Here, it is assumed that the number of prediction modes, N, is the value provided by dividing the maximum pixel rate RMAX at which the hardware can perform encoding processing by the product of frame rate F and image size S of input video image data as shown in expression (12).

$$N = \frac{{R}_{MAX}}{F \cdot S} \qquad ( 12 )$$

The number of prediction modes may be made able to be found by a table lookup from the frame rate and the image size of video image data without calculating the product of the frame rate and the image size or dividing the maximum pixel rate by the product.

If the frame rate of input video image data is constant, the number of prediction modes may be made able to be found, for example, by a table lookup only from the image size of input video image data. In contrast, if the image size of input video image data is constant, the number of prediction modes may be made able to be found, for example, by a table lookup only from the frame rate of input video image data.

The prediction modes to be selected may be prediction modes different in pixel block shape or may be prediction modes different in reference frame used for motion compensation. Alternatively, a prediction residual signal is calculated for all prediction modes and as many prediction modes as the determined number may be made able to be selected in the ascending order of the prediction residual signal size.

Next, the CPU 501 controls the hardware, reads a reference image into the local memory from the external memory 506 for each selected prediction mode, operates a hardware pipeline, performs encoding processing for the pixel block, and finds the code amount produced by performing the encoding processing (step S702) and finds the encoding distortion produced by performing the encoding processing (step S703).

The code amount produced by performing the encoding processing may be found by actually performing arithmetic encoding of a variable-length symbol in the CABAC/NAL/BS 511 or may be found by estimating from a variable-length symbol, for example, according to expression (13).
R=a·S_{DCT}+b·S_{OH} (13)

In the expression (13), “R” represents the estimated value of the code amount produced by performing the encoding processing, SDCT is the symbol length obtained from the orthogonal transformation coefficient of prediction residual signals, S_{OH} is the symbol length obtained from additional information relevant to the prediction mode, and a and b are weighting factors for the symbol lengths.

When the code amount and the encoding distortion produced by performing the encoding processing are found for all selected prediction modes, the CPU 501 finds the weighted sum of the code amount and the encoding distortion produced by performing the encoding processing for each prediction mode and selects the prediction mode corresponding to the smallest weighted sum (step S704).

The coded data corresponding to the selected prediction mode is output by the DMAC 502 through the external bus 505 (step S705).

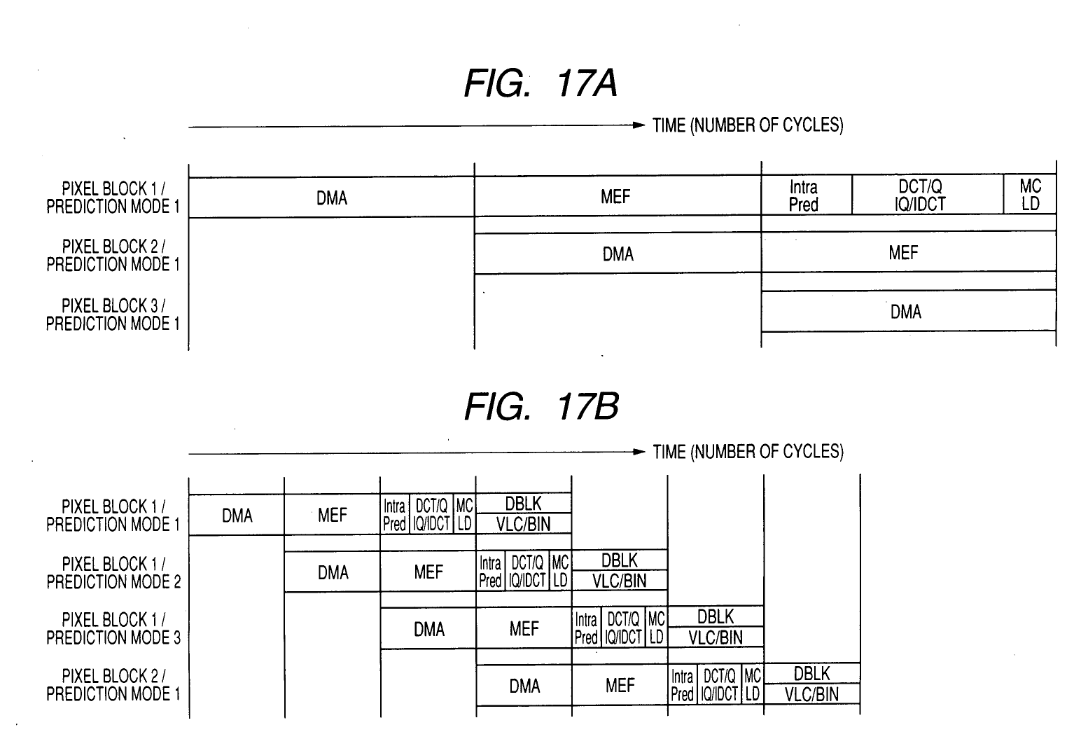

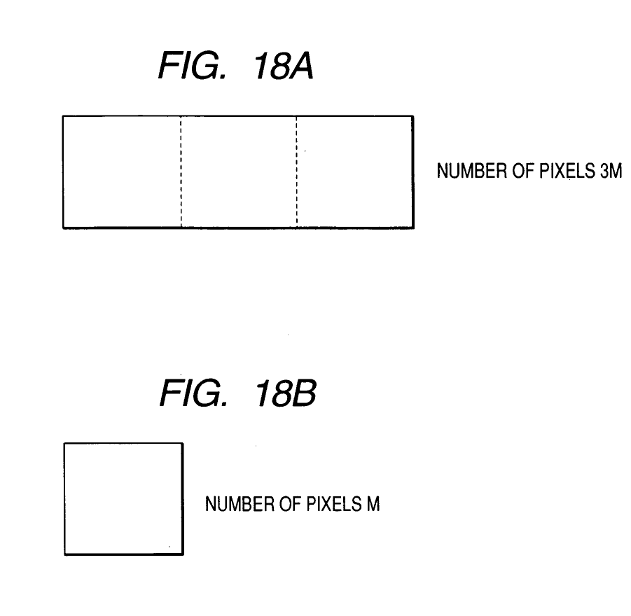

FIGS. 17A and 17B are drawings to show timing chart examples of the pipeline operation for encoding one video image with the number of pixels of the image of each frame (image size) being 3 M (FIG. 18A) and one video image with the number of pixels of the image of each frame being M (FIG. 18B) by the video image encoder according to the fifth embodiment. It is assumed that the frame rates of the two video images are the same.

At this time, if the value provided by dividing the maximum pixel rate at which the hardware can perform encoding processing by the product of the frame rate and the image size of input video image data is found according to expression (12) for each of the images shown in FIG. 18A and FIG. 18B, the ratio becomes 1:3. Therefore, to perform encoding processing for the image in FIG. 18A using one prediction mode (prediction mode “1”) for each pixel block as shown in FIG. 17A, if the image in FIG. 18B is encoded using three prediction modes (prediction modes 1 to 3) for each pixel block as shown in FIG. 17B, it is made possible to perform encoding making the most of the hardware resources.

Thus, the video image encoder according to the fifth embodiment first selects as many prediction modes as a given number from among prediction modes in response to the maximum pixel rate at which the hardware can perform encoding processing, the frame rate of video image data, and the image size of video image data and performs encoding processing only for the selected prediction mode, so that it is made possible to perform encoding processing using the hardware resources efficiently.

That is, in the example of recording a program a high-definition TV (HDTV) described above, if the horizontal size of a screen is halved for encoding, it is made possible to perform encoding processing for as many prediction modes as the number twice that for normal encoding; if a program on a high-definition TV (HDTV) is down converted into a program on a standard quality TV (SDVT), the pixel rate becomes one sixth that for HDTV and thus it is made possible to perform encoding processing for as many prediction modes as the number six times that for normal encoding.

In the fifth embodiment described above, the number of prediction modes is determined so that encoding making the most of the hardware resources can be performed from the frame rate of video image data and the image size of video image data, but the number of prediction modes may be thus determined before as many prediction modes as the number lower than the determined number of prediction modes are selected. In this case, there is a surplus of the hardware resources, but it is made possible to guarantee the real-time property of the encoding processing.

As described with reference to the embodiments, the prediction mode is selected by estimating the code amount produced as encoding processing is performed from the orthogonal transformation coefficients of the prediction residual signals for each prediction mode, so that the need for performing actual encoding to select the prediction mode is eliminated. Thus, it is made possible to select the prediction mode without increasing the computation amount or the hardware scale for selecting the prediction mode.

The foregoing description of the embodiments has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. A method for encoding a video image, the method comprising:
generating a prediction image for each of a plurality of pixel blocks that are divided from an input image into a predetermined size, and generating a prediction residual signal that indicates prediction residual between the prediction image and each of the pixel blocks, for each of a plurality of prediction modes;
obtaining an orthogonal transformation coefficient by performing orthogonal transformation to the prediction residual signal corresponding to each of the prediction modes;
selecting a target prediction mode from among the prediction modes based on a number of the orthogonal transformation coefficients that become non-zero as a quantization processing is performed;
encoding each of the pixel blocks in the target prediction mode respectively selected.

2. The method according to claim 1, wherein, when selecting the target prediction mode, a prediction mode in which the number of the orthogonal transformation coefficients that become non-zero is the smallest is selected as the target prediction mode.

3. The method according to claim 1, wherein each of the prediction modes includes at least one of a combination of motion compensation parameters and a combination of prediction parameters,
wherein the motion compensation parameters include a shape of a motion compensation prediction block and a number of reference image, both for generating the prediction image in interframe prediction processing, and
wherein the prediction parameters include a division size of a local decode image and a number of a prediction expression to be used, both for generating the prediction image in intraframe prediction processing.

4. The method according to claim 1, wherein the target prediction mode is selected by performing processes including:
obtaining the number of the orthogonal transformation coefficients that become non-zero as the quantization processing is performed;
estimating a code amount produced by encoding each of the orthogonal transformation coefficients based on the number obtained; and
selecting the target prediction mode based on the code amount estimated by the estimation section.

5. The method according to claim 4, wherein a prediction mode that the estimated code amount becomes the smallest is selected as the target prediction mode.

6. The method according to claim 4, wherein the code amount is estimated by multiplying a number of coefficients that becomes non-zero by a predetermined weighting factor for each of the prediction modes.

7. The method according to claim 6, wherein the target prediction mode is selected by performing processes that further includes updating the weighting factor based on the code amount produced by encoding the orthogonal transformation coefficients using the selected target prediction mode and the number of coefficients that become non-zero as quantization processing is performed, of the orthogonal transformation coefficients involved in the selected target prediction mode.

8. The method according to claim 1, wherein the target prediction mode is selected by performing processes including:
estimating a first code amount produced by encoding each of the orthogonal transformation coefficients based on the number obtained;
estimating a second code amount produced by encoding additional information relevant to each of the prediction modes; and
selecting the target prediction mode based on the first code amount and the second code amount.

9. The method according to claim 8, wherein the target prediction mode is selected by performing processes including:
obtaining a weighted sum of the first code amount and the second code amount for each of the prediction modes; and
selecting a prediction mode having the smallest weighted sum as the target prediction mode.

10. The method according to claim 8, wherein the additional information includes at least one of a motion vector for generating the prediction image, a number of a prediction expression for generating a prediction image, and a shape of the pixel block.

11. The method according to claim 8, wherein the second code amount is estimated by multiplying a sum total of symbol lengths obtained by converting the additional information into binarization symbol by a given weighting factor.

12. The method according to claim 8, further comprising estimating an encoding distortion produced by encoding each of the orthogonal transformation coefficients,
wherein the target prediction mode is selected based on the first code amount, the second code amount, and the encoding distortion.

13. The method according to claim 12, wherein the target prediction mode is selected by performing processes including:
obtaining a weighted sum of the first code amount, the second code amount, and the encoding distortion for each of the prediction modes; and
selecting a prediction mode having the smallest weighted sum as the target prediction mode.

14. The method according to claim 12, wherein the encoding distortion is estimated by: cumulatively adding a value resulting from squaring the orthogonal transformation coefficient for each of the orthogonal transformation coefficients that become zero as quantization processing is performed; and cumulatively adding a predetermined value for each of the orthogonal transformation coefficients that become non-zero as quantization processing is performed.

15. The method according to claim 12, wherein the encoding distortion is estimated by: cumulatively adding an absolute value of the orthogonal transformation coefficient for each of the orthogonal transformation coefficients that become zero as quantization processing is performed; and cumulatively adding a predetermined value for each of the orthogonal transformation coefficients that become non-zero as quantization processing is performed.

16. A method for encoding a video image, the method comprising:
selecting a plurality of second prediction modes from among a plurality of first prediction modes based on a pixel rate determined by a frame rate and an image size of an input image, for each of a plurality of pixel blocks that are divided from the input image into a predetermined size;
obtaining a coding amount produced by encoding each of the pixel blocks for each of the second prediction modes;
obtaining an encoding distortion produced by encoding each of the pixel blocks for each of the second prediction modes;
selecting a target prediction mode from among the second prediction modes based on the coding amount and the encoding distortion; and
encoding each of the pixel blocks in the target prediction mode respectively selected by the selection unit.

17. The method according to claim 16, wherein the encoding distortion is obtained by estimating the encoding distortion produced when each of the pixel blocks are encoded in each of the second prediction modes.

18. The method according to claim 16, wherein for a second pixel rate smaller than a first pixel rate, as many second prediction modes as a number equal to or greater than a number of the second prediction modes selected for the first pixel rate, are selected.

19. The method according to claim 16, wherein as many second prediction modes as a number provided by dividing the maximum pixel rate at which hardware can perform encoding processing by the pixel rate determined by the frame rate and the image size of the video image from among the first prediction modes, are selected.

20. The method according to claim 16, wherein the second prediction modes are selected by performing processes including:
obtaining a weighted sum of the code amount and the encoding distortion for each of the second prediction modes; and
selecting prediction modes having the smallest weighted sum as the second prediction modes.

21. A video image encoder comprising:
a generation unit that generates a prediction image for each of a plurality of pixel blocks that are divided from an input image into a predetermined size, and generates a prediction residual signal that indicates prediction residual between the prediction image and each of the pixel blocks, for each of a plurality of prediction modes;
an orthogonal transformation unit that obtains an orthogonal transformation coefficient by performing orthogonal transformation to the prediction residual signal corresponding to each of the prediction modes;
a selection unit that selects a target prediction mode from among the prediction modes based on a number of the orthogonal transformation coefficients that become non-zero as a quantization processing is performed;
an encoding unit that encodes each of the pixel blocks in the target prediction mode respectively selected by the selection unit.

22. The video image encoder according to claim 21, wherein the selection unit includes:
a calculation section that obtains the number of the orthogonal transformation coefficients that become non-zero as,the quantization processing is performed;
an estimation section that estimates a code amount produced by encoding each of the orthogonal transformation coefficients based on the number obtained by the calculation section; and
a selection section that selects the target prediction mode based on the code amount estimated by the estimation section.

23. The video image encoder according to claim 21, wherein the selection unit includes:
a first estimation section that estimates a first code amount produced by encoding each of the orthogonal transformation coefficients based on the number obtained by the calculation section;
a second estimation section that estimates a second code amount produced by encoding additional information relevant to each of the prediction modes; and
a selection section that selects the target prediction mode based on the first code amount and the second code amount.

24. The video image encoder according to claim 23, wherein the selection unit further includes a third estimation section that estimates an encoding distortion produced by encoding each of the orthogonal transformation coefficients, and
wherein the selection section selects the target prediction mode based on the first code amount, the second code amount, and the encoding distortion estimated by the estimation section.

25. A video image encoder comprising:
a first selection unit that selects a plurality of second prediction modes from among a plurality of first prediction modes based on a pixel rate determined by a frame rate and an image size of an input image, for each of a plurality of pixel blocks that are divided from the input image into a predetermined size;
a first obtaining unit that obtains a coding amount produced by encoding each of the pixel blocks for each of the second prediction modes;
a second obtaining unit that obtains an encoding distortion produced by encoding each of the pixel blocks for each of the second prediction modes;
a second selection unit that selects a target prediction mode from among the second prediction modes based on the coding amount and the encoding distortion; and
an encoding unit that encodes each of the pixel blocks in the target prediction mode respectively selected by the selection unit.

26. A computer readable program product that causes a computer system to perform processes comprising:
generating a prediction image for each of a plurality of pixel blocks that are divided from an input image into a predetermined size, and generating a prediction residual signal that indicates prediction residual between the prediction image and each of the pixel blocks, for each of a plurality of prediction modes;
obtaining an orthogonal transformation coefficient by performing orthogonal transformation to the prediction residual signal corresponding to each of the prediction modes;
selecting a target prediction mode from among the prediction modes based on a number of the orthogonal transformation coefficients that become non-zero as a quantization processing is performed;
encoding each of the pixel blocks in the target prediction mode respectively selected.

27. A computer readable program product that causes a computer system to perform processes comprising:
selecting a plurality of second prediction modes from among a plurality of first prediction modes based on a pixel rate determined by a frame rate and an image size of an input image, for each of a plurality of pixel blocks that are divided from the input image into a predetermined size;
obtaining a coding amount produced by encoding each of the pixel blocks for each of the second prediction modes;
obtaining an encoding distortion produced by encoding each of the pixel blocks for each of the second prediction modes;
selecting a target prediction mode from among the second prediction modes based on the coding amount and the encoding distortion; and
encoding each of the pixel blocks in the target prediction mode respectively selected by the selection unit.
